(19) United States
(12) Patent Application Publication
(10) Pub. No.: US 2016/0148609 A1
(43) Pub. Date: May 26, 2016

(54) DETECTING EVENTS FROM COUPLED SENSORS

(71) Applicant: Incident Technologies, Inc., San Francisco, CA (US)

(72) Inventors: Idan Beck, San Francisco, CA (US); Benjamin Michael Altieri, Mountain View, CA (US)

(21) Appl. No.: 14/549,386

(22) Filed: Nov. 20, 2014

(51) Int. Cl. G10H 3/18; G10H 3/14

(52) U.S. Cl. CPC G10H 3/186; G10H 3/181; G10H 3/143; G10H 2220/485; G10H 2220/471; G10H 2250/131

(57) ABSTRACT

Disclosed herein are systems, methods, and non-transitory computer-readable media for detecting events from coupled sensors. The method includes receiving a plurality of signals from coupled sensors and processing the plurality of signals to obtain characterization data for each of the signals. The characterization data is used with a state machine to determine at least one event that caused the coupled sensors to output the plurality of signals. Control signals are created that can be used to reproduce or represent the at least one event.

### CROSS REFERENCE TO RELATED APPLICATIONS

This Application is related to U.S. patent application Ser. No. 14/216,523, entitled “Musical Input Device and Dynamic Thresholding”, filed on Mar. 17, 2014 and which is incorporated herein in its entirety.

### TECHNICAL FIELD

The present technology pertains to detecting events from sensors that are coupled to each other.

### BACKGROUND

A system that includes multiple sensors used to detect user input presents unique challenges because more than one of the sensors may inadvertently detect a single user input. The sensors in this system can be described as coupled sensors. The inadvertent detection by a coupled sensor may be due to the proximity of the sensors or due to mechanical or electrical coupling at inputs to the sensors. Consequently, the processor will receive signals from each of the coupled sensors that detect the input and must intelligently process the signals to determine the intended user input while discounting the signals caused by the coupling.

### SUMMARY

Additional features and advantages of the disclosure will be set forth in the description that follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As explained above, the approaches set forth herein can be used to process signals from coupled sensors to produce pertinent characterization data from each of the individual signals while discounting undesired contributions from the coupling. The characterization data can then be used to determine the event that caused the signals. Thus, the present technology can generate and use characterization data to compensate for coupling and unintended signals in order to determine the initial user input or event. Disclosed are systems, methods, and non-transitory computer-readable media for creating and processing the present technology.

In one aspect of the present disclosure, a method for detecting events from coupled sensors in a system is disclosed. The method includes receiving a plurality of signals from the coupled sensors and processing the plurality of signals to obtain characterization data for each of the signals. Based on the characterization data and using at least one state machine representing the system, determining at least one event that caused the coupled sensors to output the plurality of signals. Control signals are created that can be used to reproduce the at least one event.

In another aspect, an apparatus comprising a plurality of coupled sensors and a processor is disclosed. The plurality of coupled sensors can detect user input and output one or more signals. The processor can receive the one or more signals from the coupled sensors and process the signals to obtain characterization data for each of them. Based on the characterization data and a state machine representing the system, the processor can determine the user input that caused the coupled sensors to output the one or more signals. Control signals are created that can be used to reproduce the user input.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and details through the use of the accompanying drawings in which:

FIG. 1 illustrates an exemplary configuration of devices and a network;

FIG. 2 illustrates an exemplary system embodiment;

FIG. 3 illustrates an exemplary software architecture for a device;

FIG. 4 illustrates an exemplary operation of the peak detection module;

FIG. 5 illustrates an exemplary signal envelope;

FIG. 6 illustrates an exemplary waveform for a string model;

FIG. 7 illustrates an exemplary method embodiment; and

FIG. 8 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for processing signals from coupled sensors in a manner that allows for the detection of the intended user input while discounting noise or signals that are due to coupling. Accordingly, a system, method and non-transitory computer readable media are disclosed which receive input signals from coupled sensors, process the input signals, detect characterization data from the input signals, and generate logic to reproduce the intended input.

Prior to discussing the present technology in detail, a brief introductory description of an exemplary configuration of devices and a network is disclosed herein. A detailed description of the various aspects of the present technology will then follow. These variations shall be described herein as the various embodiments are set forth.

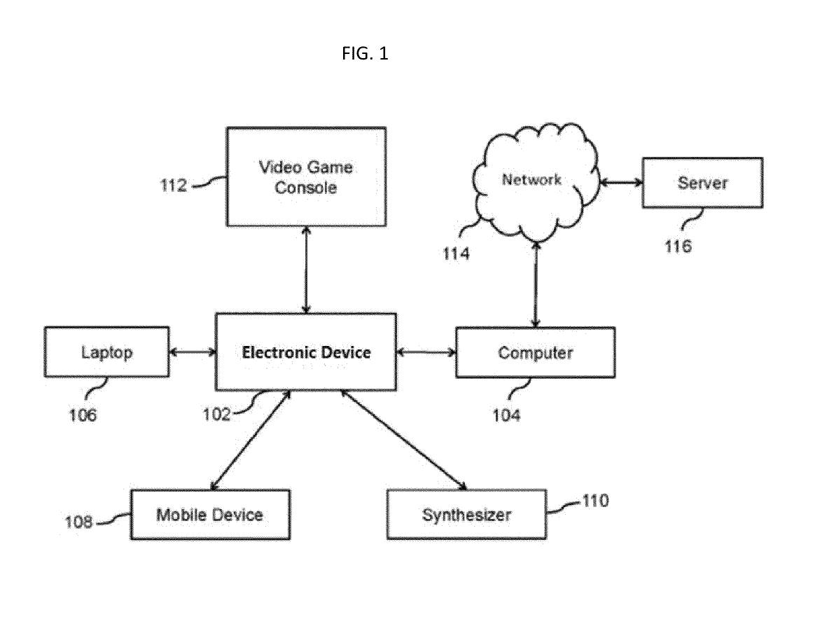

FIG. 1 illustrates an exemplary configuration of devices and a network where various embodiments of the invention function. A user may provide input, via sensors, to an electronic device 102 that can generate output signals. Examples of the electronic device 102 include, but are not limited to, devices that look like a guitar, a violin, viola, cello or any other stringed musical instrument. Alternatively, the present technology may be applied to any application or device that includes cross-coupled mechanical sensors, such may be found in robotic arms or automobiles. These examples are not intended to limit the scope of the present technology. One that is skilled in the art will recognize that the present technology may be applied in a number of different devices.

The output signals generated by the electronic device 102 may correspond to musical information. For example, the output signals may include Musical Instrument Digital Interface (MIDI) signals. Furthermore, output signals may be used to control video games. The electronic device 102 may communicate with various external devices through interfaces such as, but not limited to, Universal Serial Bus (USB), Recommended Standard (RS) 232, Registered Jack (RJ) 45, or other wired or wireless interfaces such as Bluetooth, Radio Frequency (RF), Infrared, or optical coupling.

As shown in FIG. 1, the electronic device 102 may communicate with a computer 104, a laptop 106, a mobile device 108, a synthesizer 110, and a video game console 112. Mobile device 108 may be for example, a mobile phone, a smart phone, a Personal desktop Assistant (PDA) and so forth. Furthermore, the electronic device 102 may be connected to a server 116 through a network 114 and computer 104. Examples of network 114 include, but are not limited to, a Local Area Network (LAN), Wide Area Network (WAN), Wireless network (Wifi), a mobile network, the Internet and so forth. Only a limited type of external devices are illustrated, however a person skilled in the art will appreciate that other type of devices that use standard means of communication can also be connected to the electronic device 102. The electronic device 102 may be used to control the external devices, for example, transmit musical note information or play a video game executing on an external device. The electronic device 102 generates digital signals based on inputs provided by the user. The digital signals may be transmitted to the external devices. Moreover, the electronic device 102 can receive information from the external devices. For example, the electronic device 102 can be controlled or configured through external devices. Therefore, the electronic device 102 can function as a bi-directional device.

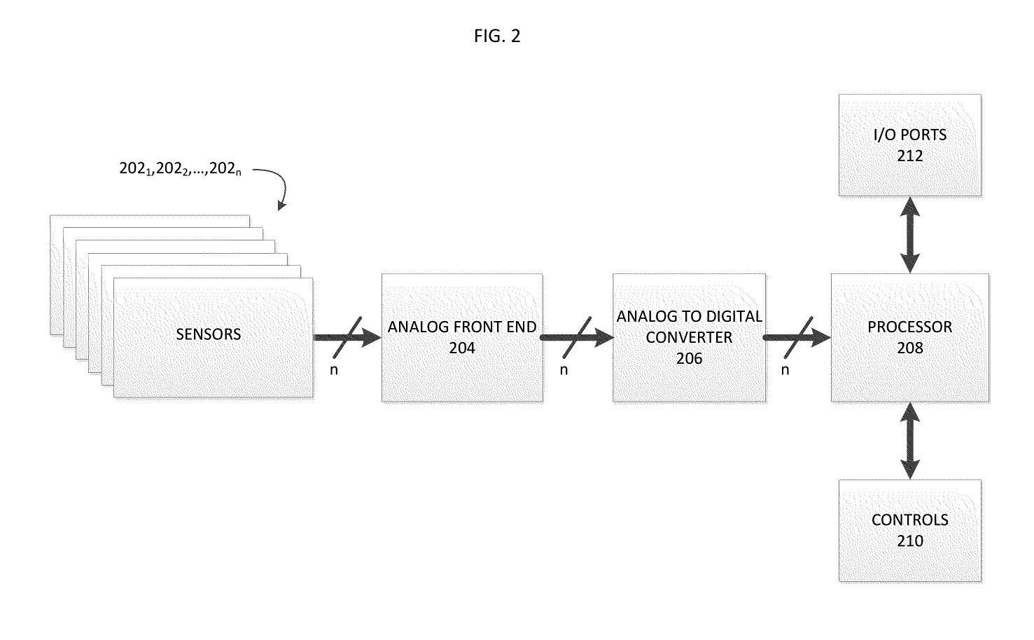

With reference to FIG. 2, an exemplary system architecture of the electronic device 102 is illustrated. The electronic device 102 may include one or more coupled sensors 202₁, 202₂, . . . , 202ₙ (collectively 202) used to detect user input. The coupled sensors 202 can output an electric signal upon the detection of a user input. These output signals can be redundant or unintentional due to the physical proximity of the sensors, electrical or mechanical interference, or electrical induction, which is often referred to as cross-talk. For example, an attempt to activate sensor 202₁ may inadvertently activate sensor 202₂, thus resulting in signals from both of these sensors with the signal from 202₂ being unintentional.

In one example, these sensors 202 can be piezoelectric sensors used to sense string vibrations on a musical instrument. Each piezoelectric sensor can be assigned to a particular position on a particular string. When the user causes a string to vibrate, signals are generated based on sensing of vibration by the sensors 202.

A vibration on one string may be detected by more than one of sensors 202, thus causing multiple sensors to output electrical signals that correspond to a single input. For example, the strings can be mechanically coupled to each other and cause two or more sensors 202 to output a signal. Similarly, the electrical output from one sensor corresponding to a particular input may cause electrical induction that results in interference with a different sensor's electrical output.

In another example, the sensors 202 can be capacitive based sensors used for detecting things such as touch, proximity, or position. Again, these types of sensors will present similar problems due to their proximity or sensitivity. Although these types of sensors are not mechanically coupled to the strings, they can also benefit from the present technology because the strings themselves can be coupled to each other, thus resulting in coupling among the sensors 202. In a further example, the sensors 202 can be Hall-Effect based sensors that detect changes in the magnetic field. In yet a further example, the sensors 202 can be optical sensors. A person skilled in the art will appreciate that the techniques disclosed herein for processing signals from coupled sensors may be applied to many different sensor types.

The electronic device 102 can also include an analog front end 204 used for conditioning the raw output signals from the sensors 202. For example, the analog front end 204 can provide a voltage bias to each of the incoming signals. The analog front end 204 can also include circuitry for filtering certain frequencies of the incoming signals. Some examples of these filters include band-pass filters, low-pass filters, and high-pass filters. In some embodiments, these filters can be used to avoid aliasing by blocking frequency content that is above the Nyquist frequency. The filters can also be used to block the Direct Current (DC) content of the signals.

In addition, the analog front end 204 may also amplify or attenuate the amplitude of the signals from the sensors 202. This conditioning may be necessary to ensure that the signals conform to an expected input range for an integrated circuit such as an analog to digital converter.

One that is skilled in the art will recognize that functions performed by the analog front end 204 may be achieved by employing many different hardware solutions. These solutions can utilize any number of discrete components such as resistors, capacitors, inductors, transistors, diodes, etc. configured in many different ways. Furthermore, certain aspects of the analog front end 204 may also be performed by integrated circuits that are specifically designed for such functions or that are programmed to perform those functions. For example, the above mentioned frequency filters (low-pass, band-pass, high-pass) can be implemented with hardware or software. Digital signal processing techniques can be used to implement these filters on a digitized signal via software that is executed on a processor.

The analog front end 204 may also include an analog to digital converter (ADC) used to digitize each of the signals from the sensors 202. Alternatively, the ADC 206 can be a standalone module in the form of an integrated circuit. In some embodiments, the processor 208 may contain an embedded module that can perform A/D conversion. Alternatively, certain sensors 202 may have digital outputs that can be passed directly to the processor 208 without the need for additional hardware to perform the conversion.

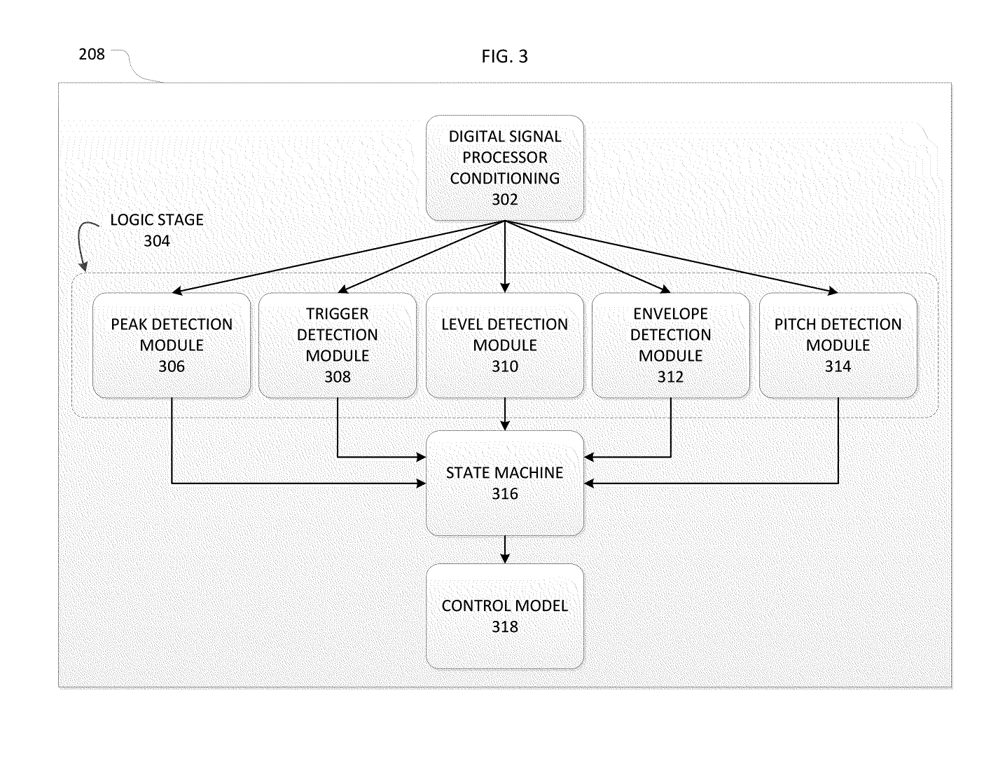

The electronic device 102 may also contain a processor 208. The processor 208 receives the signals generated by the coupled sensors 202. Processor 208 may contain one or more modules adapted to perform various levels of signal processing on the signals. These modules are discussed in greater detail with reference to FIG. 3.

In general, the modules within processor 208 can perform parallel processing on all of the signals from the coupled sensors 202 to extract pertinent characterization data and detect the event that caused the signals. Processor 208 can perform this function while discounting the unintended contributions from the coupled sensors. The processor 208 can use the characterization data extracted from each of the signals to generate control logic for a state machine. The state machine can be used with the characterization data to determine the event that cause the signals and manipulate a control model that will generate signals to recreate the event.

Processor 208 may be connected to multiple Input/Output (I/O) ports 212. The output signals generated by processor 208 are transmitted to the external devices through I/O ports 212. Moreover, I/O ports 212 may receive external signals from the external devices such as those depicted in FIG. 1. Thereafter, processor 208 may process the external signals. The external signals may include signals to control or configure the electronic device 102. Therefore, electronic device 102 functions as a bi-directional communication device. Examples of I/O ports 212 include, but are not limited to USB, Firewire, RS232, RJ45, or other wired or wireless communication means such as RF or Bluetooth. Further, the electronic device 102 may include controls 210 to control various features or modes of the electronic device 102. For example, the user may control the volume output, the mode of the electronic device 102, and other features from controls 210.

An exemplary software architecture for processor 208 is illustrated in FIG. 3. The architecture includes a digital signal processor (DSP) conditioning block 302, a logic stage 304, a state machine 316, and a control model 318. The logic stage 304 can incorporate modules such as a peak detection module 306, a trigger detection module 308, a level detection module 310, an envelope detection module 312, and a pitch detection module 314. The logic stage 304 can be structured in a scalable manner that allows modules to be added or removed without impacting the other modules or the overall performance of electronic device 102. In some embodiments, the modules can be enabled and disabled individually. Thus, the overall system performance can be improved by selectively enabling each particular module as it is needed.

The DSP conditioning block 302 complements the analog front end 204. It receives digitized versions of the coupled signals and can adjust them by using DSP filtering techniques. The DSP conditioning block 302 can also include algorithms that improve the signal to noise ratio (SNR) of the incoming coupled signals, thus allowing for more efficient processing of the coupled signals by the logic stage 304.

Turning to the logic stage 304, it includes modules that process each of the signals and obtains characterization data from those signals. The modules can use the characterization data to generate control logic for a state machine 316. The modules in the logic stage 304 are each replicated for the individual signals.

Peak detection module 306 can examine each of the signals and identify local minimum values and local maximum values. The output of the peak detection module 306 is the absolute value of the identified minimum and maximum values for each signal. Therefore, the peak detection module 306 can be used as an instantaneous signal envelope detector.

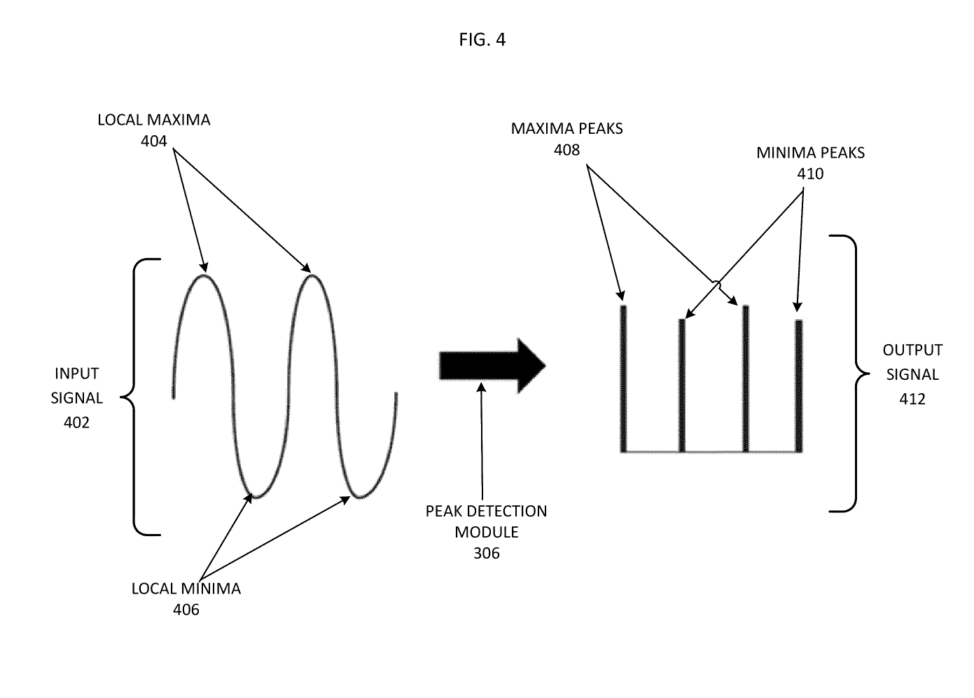

FIG. 4 illustrates the operation of the peak detection module 306. Input signal 402 is received by peak detection module 306 and is analyzed to identify local maxima 404 and local minima 406. Peak detection module 306 generates output signal 412 that is made up of discrete signals that correspond to the maxima peaks 408 and the minima peaks 410. The output signal 412 does not contain any negative signal components because peak detection module uses the absolute value of local maxima 404 and local minima 406 to generate output signal 412.

Trigger detection module 308 determines when a pre-defined trigger event has occurred. The pre-defined trigger events can be related to characteristics of the signal such as level, amplitude, slope, rise-time, fall-time, or frequency or any combination thereof. For example, a trigger may be detected when the signal level either exceeds or is beneath a certain threshold. The trigger detection module 308 may fire immediately upon detecting the threshold level or it may require that the signal maintain the threshold for a period of time before identifying that a trigger has occurred.

Similarly, the trigger detection module 308 may identify a trigger when the slope of the signal meets certain criteria. One technique for detecting the signal slope is by using the root mean square (RMS) value of the signal. For instance, when the RMS value increases or decreases at a certain rate, a trigger can be generated. The RMS value used herein is a run-time value and those that are skilled in the art will recognize that alternative run-time means can be used. For example, a simple run-time (arithmetic) mean value or a different run-time filter can be used to detect the signal slope. In some embodiments, the technique can be further enhanced by using frequency filters to clean up the raw RMS signal and avoid false trigger detections. Examples of frequency filters include high-pass filters, low-pass filters and band-pass filters.

In one embodiment, the signal can be received from a sensor that is coupled to a string on a guitar. The slope of the raw RMS signal can be used to detect user input on the string by monitoring the rate at which the slope changes. Alternatively, the slope can be detected from an RMS signal that is processed with a high-pass frequency filter. Using the filtered RMS signal can avoid false trigger detections that are caused by buzz or vibrations associated with a pick used to strum the guitar strings. The high-pass filter can remove undesired “pick buzz” frequency components while keeping the fundamental frequency associated with the string. In another embodiment, buzz can be detected by analyzing two run-time signal values in parallel. For example, one run-time signal can be the RMS signal value and the other can be a run-time mean value. Because the buzz is associated with a broad frequency spectrum, it can be detected by observing a transient response on one of the two run-time signals.

Furthermore, a combination of the raw RMS signal and the filtered RMS signal can be used to intelligently detect and/or inhibit detected triggers. For example, the raw RMS signal may detect a trigger condition that is caused by guitar pick buzz. This trigger condition can be inhibited by processing the filtered RMS signal in parallel to determine if a corresponding trigger condition was also detected on the filtered RMS signal.

In another example, the trigger detection module 308 may identify a trigger when the frequency content of the signal satisfies certain conditions. For example, the trigger detection module 308 may identify a trigger when the frequency content of the signal is within a specified range for a particular musical note. Furthermore, the trigger detection module 308 may also identify a trigger based on a combination of the aforementioned methods. For example, a trigger can be based on a combination of a particular frequency and particular amplitude.

In one example, the frequency of the signal can be analyzed using the Fourier transform of the incoming signal. The Fourier transform can be used to take the signal from the time domain to the frequency domain. The resulting frequency spectrum can be used to determine if a frequency trigger event has occurred.

In another example, the frequency of the signal can be analyzed by detecting the wavelength of the signal. The wavelength can be detected by measuring the time between zero crossing points of the signal. Alternatively, the wavelength can be detected by measuring the time between wave crests (peaks) or wave troughs. Dynamic measurement of the wavelength can be used to determine the present signal frequency and to detect changes in frequency. A trigger event can be generated according to a particular frequency or to a change in frequency.

As mentioned above, the modules in the logic stage 304 are replicated for each of the coupled signals that are inputs to the processor 208. Each respective module can query data from modules corresponding to other inputs. For example, a trigger detection module 308₁ associated with a first signal can query a trigger detection module 308₂ that is associated with a second signal and intelligently inhibit an identified trigger when the trigger detection module 308₁ determines that the identified trigger is associated with coupling or cross-talk from a coupled sensor. In some embodiments, each respective module can maintain a matrix of the input signals and use it to intelligently inhibit invalid triggers. Furthermore, the cross-talk matrix can also be maintained by a distinct cross-talk module that keeps track of each corresponding signal.

In one example, the trigger detection module 308 may identify frequency content on a signal that would normally result in a trigger condition. However, the trigger detection module 308 may use the cross-talk matrix to determine that similar frequency content is present on a signal from a different sensor and that it should inhibit its trigger because the other signal from the other sensor has priority due to its signal characteristics. For instance, the amplitude of the signal from the adjacent channel may be significantly greater, which would indicate that the detected trigger is due to cross-talk and should be inhibited. A detailed description of the systems and methods used for cross-talk suppression can be found in U.S. patent application Ser. No. 14/216,523, entitled “Musical Input Device and Dynamic Thresholding,” and incorporated by reference herein in its entirety.

Level detection module 310 can process the signals to detect the instantaneous signal level or the average signal level over an identified time window. The level detection module 310 can use different methods for performing its function. In one example, the level detection module 310 can use a running root mean square (RMS) algorithm to determine the signal level. In another example, the level detection module 310 can use a running arithmetic mean algorithm to determine the signal level. Those skilled in the art will appreciate that various techniques can be used to perform this function.

Envelope detection module 312 can process the coupled signals to determine the running time envelope of each signal. The signal envelope is a boundary curve that traces a signal's amplitude over time. The signal envelope encloses the area outlined by all maxima of the signal. The envelope detection module may perform this function by using techniques similar to those used in other modules, such as a peak detection algorithm, a running RMS algorithm, or a running arithmetic mean algorithm. Alternatively, a rectifier or a low-pass filter can also be used to perform envelope detection. The image below illustrates the signal envelope waveform that is generated by the envelope detection module 312.

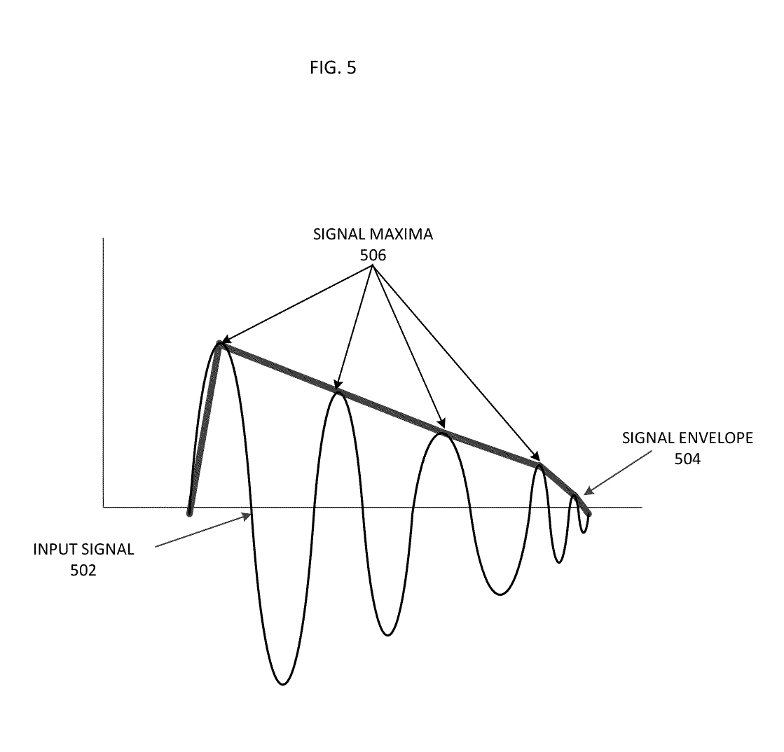

FIG. 5 illustrates the function of envelope detection module 312. Input signal 502 is received by envelope detection module 312 and processed to identify its amplitude over time. Envelope detection module 312 generates an output waveform represented by signal envelope 504 that encloses the area outline by all of the signal maxima 506.

Pitch detection module 314 can receive signals from each of the coupled sensors and perform an algorithm that can estimate the corresponding fundamental frequency for each of the signals. In one example, the pitch detection module 314 can estimate the fundamental frequency by measuring the distance between the input signals zero crossing points. Alternatively, the pitch detection module 314 can estimate the fundamental frequency by measuring the wavelength of the signal. These techniques for determining the fundamental frequency can be performed in the time domain.

In another example, the pitch detection module 314 can estimate the fundamental frequency by using more complex digital signal processing techniques that manipulate the signal in the frequency domain. These techniques can be used to analyze the frequency spectrum and determine the fundamental frequency. Those skilled in the art will recognize that various digital signal processing techniques may be used to determine the fundamental frequency.

Having determined the fundamental frequency, pitch detection module 314 can determine the drift from the fundamental frequency by monitoring the changes in frequency. In one embodiment, the pitch detection module 314 can be used to detect pitch bend on a guitar string that is coupled to a sensor. The sensor will output a signal used by the pitch detection module 314 to determine the corresponding fundamental frequency by monitoring the signal's zero crossing points or the signal wavelength. If the user bends the guitar string, the intended pitch change can be detected according to the drift from the fundamental frequency. The pitch detection module 314 can use any frequency as the fundamental frequency reference point so it can detect pitch change on the guitar string even if the guitar is not properly tuned.

In an alternative embodiment, the pitch detection module 314 can detect pitch changes by monitoring the voltage signal of a piezoelectric sensor coupled to the guitar string. The piezoelectric sensor's output voltage signal can exhibit a bump or a bounce that results from the displacement caused by the string bend. Similarly, the output voltage can exhibit a droop when the piezoelectric sensor returns to its original (un-displaced) position. Accordingly, pitch detection module 314 can detect pitch changes by capturing the spikes and droops that correspond to the string bends.

State machine 316 can receive inputs from each of the modules in the logic state 304 that correspond to characterization data for each of signals. The state machine 316 can use the inputs to detect the corresponding events and generate control logic for the control model 318 to interface with a PHY interface to recreate one or more of the signals without the content that is attributable to coupling or interference.

In one example, the signals are generated by piezoelectric sensors configured to detect mechanical vibrations on the strings of an instrument such as a guitar. The modules in the logic stage 304 can process the signals in the manner describe above and generate control logic for the state machine 316.

In turn, the state machine 316 can manipulate a string model that generates control signals operative for recreating musical notes that correspond to the notes that were intended to be played on the string instrument. Using the characterization data detected at the logic stage 304, the state machine 316 can generate string model commands such as trigger, attack, decay, sustain, note-off, and release for control model 318.

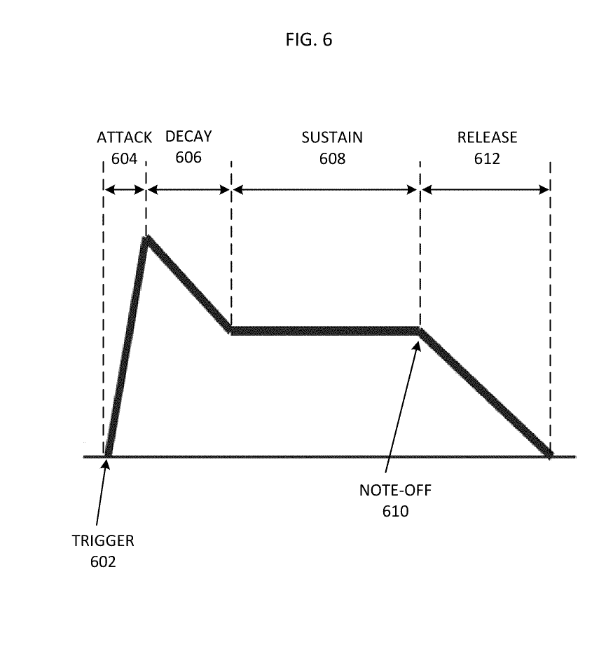

FIG. 6 is an exemplary waveform with the portions of the waveform identified according to the string model corresponding command. In FIG. 6, trigger 602 corresponds to the detection of a musical note. Trigger 602 signals the beginning of the note and is followed by attack 604 which controls the time it takes for the note to reach its initial level. Decay 606 follows attack 604 and corresponds to the time it takes for the note to transition from its initial level to a steady-state level. The duration of the steady-state level is controlled by sustain 608. Note-off 610 triggers the end of the sustain 608 period and initiates release 612. Release 612 is the command that controls the time it takes for the note to fade away, ending the cycle.

The commands from the state machine 316 can be interpreted by a control model 318 to recreate an input signal that corresponds to the detected user event. The state machine 316 can send these commands to control model 318 in nearly real-time such that there is minimal latency from the time the signals enter processor 208 to the time control model 318 generates the clean output waveform.

Continuing with the example above corresponding to a string instrument, the control model 318 can take the various string model commands and convert them to output data that corresponds to the intended musical note. In some embodiments, this output data can be used by an external host to play the intended musical note in a MIDI format. Alternatively, the output data can correspond to the amplitude of a signal while excluding the frequency component of the note. For example, the output data can be used to reproduce a “string pluck” event on the string instrument and the pitch/note information can be supplemented outside of the system.

For example, the “trigger” command can be converted to a note-on command to indicate to the external host that a note has been triggered. Similarly, the “decay” and “sustain” commands can be converted to control volume changes. The “note-off” command can be interpreted to terminate the musical note. Finally, the “release” command can control the time it takes for the note to turn off.

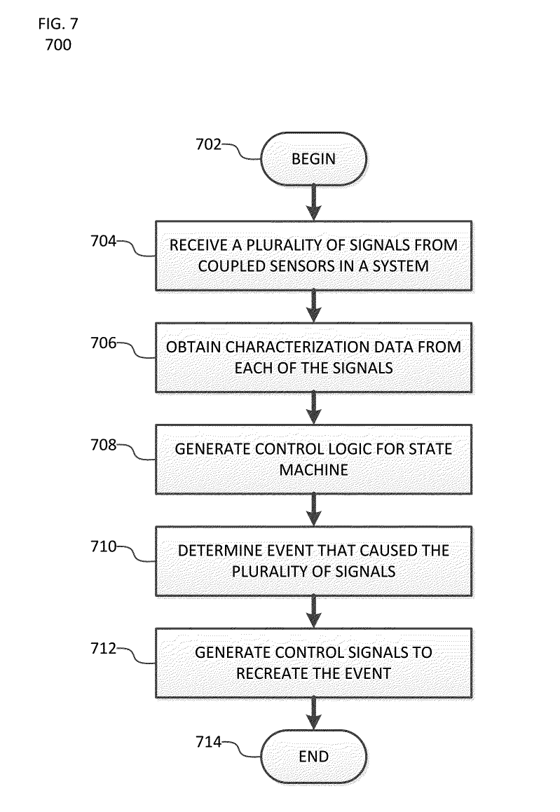

FIG. 7 is a flowchart illustrating an exemplary method for performing the present technology. The method 700 begins at step 402 and continues to step 404. At 404, the processor receives a plurality of signals from coupled sensors. For example, an array of piezoelectric sensors configured in close proximity to each other may all detect a single user input as a result of mechanical coupling. Consequently, each of the coupled sensors will send a signal to the processor that corresponds to the user input.

The method continues at 706 where it detects characterization data from each of the signals. The characterization data detected can include signal characteristics such as a signal envelope, a minimum value, a maximum value, or an average value. Furthermore, the characterization data detected can also include detecting triggers associated with a particular voltage threshold or particular frequency content. In some embodiments, step 706 can be performed by one or more modules that are part of a logic stage, as illustrated in FIG. 3.

At step 708, the method uses the characterization data to generate control logic for a state machine that represents the system. This characterization data can be used by the state machine at 710 to determine an event that caused the signals from the coupled sensors.

In turn, at step 712 the state machine generates control signals that can be used to recreate the event. For example, the state machine can generate an input signal that can be used by a control model to recreate at least one of the signals from the coupled sensors that corresponds to the intended user input.

In one example, process 700 can be used to recreate a waveform that corresponds to a musical note on a string instrument. The signals received at 704 can be generated by sensors configured to detect vibrations on the strings of a musical instrument. For instance, a user may intend to cause a vibration on the second string of a guitar, but mechanical coupling or lack of skill may result in vibrations on the first, second and third strings. Each of the respective sensors will detect these vibrations and send output signals to the processor. These signals are related to each other because they correspond to coupled sensors and each of them carries information related to vibrations that were inadvertently detected from another string. In this example, the signal from the second string is intended by the user but contains data associated with the vibration of strings one and three.

Continuing with the example, at 706 the process can obtain characterization data from each of the signals received. The characterization data can include frequency content, minimum, maximum, signal envelope, etc. This characterization data can be used to generate control logic for a state machine that represents the system. In this example, the state machine implements a string model that corresponds to a guitar. By using the characterization data, the state machine can determine that the intended input corresponds to the signal from the second string and that the signals from strings one and three should be discarded.

Once the state machine has identified the event that caused the input signals, it proceeds to step 712 wherein it generates control signals to recreate the event. For example, the state machine can send musical note model commands to a control model for recreating the note. As previously discussed, these commands can include trigger, attack, decay, sustain, note-off, and release. The control model can translate the commands from the state machine to recreate the intended note from string two, without the noise from string one or string 3.

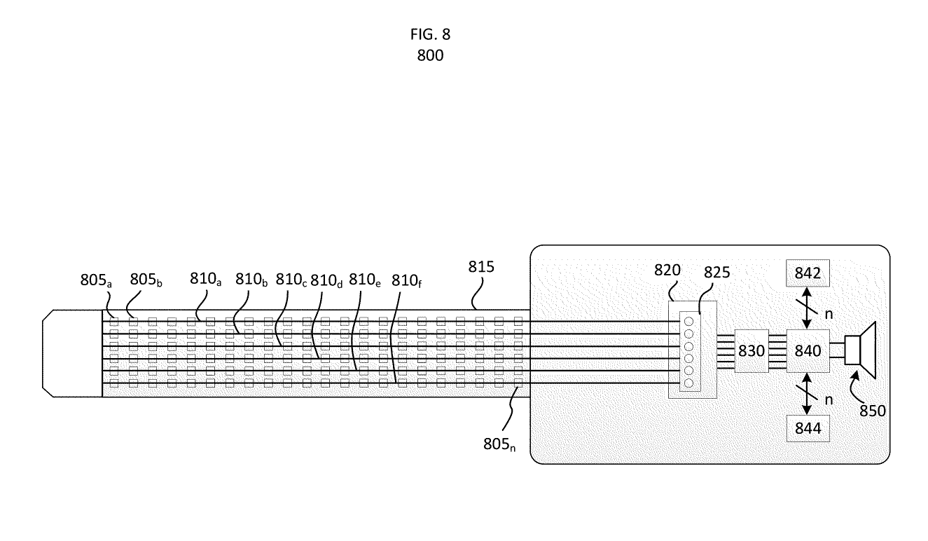

FIG. 8 illustrates an exemplary electronic device 800 that can utilize the present technology. The electronic device 800 in FIG. 8 is in the shape of a guitar, and it includes a plurality of contacts 805ₐ, 805_{b} . . . 805ₙ arranged on a neck 815. The contacts 805ₙ can be electrically coupled to an array of piezoelectric sensors 825 located inside bridge 820 (electric coupling not shown).

The contacts 805ₙ are arranged on neck 815 such that they can be used by the piezoelectric sensors 825 to detect user inputs from strings 810ₐ, 810_{b}, 810_{c}, 810_{d}, 810ₑ, and 810_{f}. When an input is detected, the piezoelectric sensors 825 can generate output signals and send the signals to an analog front end 830. As can be observed from FIG. 8, the close proximity of contacts 805ₙ causes the corresponding sensors 825 to be coupled to each other. An single user input can easily trigger output signals from more than one of sensors 825. As described in FIG. 2, the analog front end 530 can condition the signals before passing them to processor 840.

Processor 840 receives the signals from the analog front end 830 and can perform further conditioning using a variety of DSP techniques. Processor 840 can further perform parallel processing on the signals to obtain characterization data. Processor 840 can perform this task using modules such as a peak detection module, a trigger detection module, a level detection module, an envelope detection module, and a pitch detection module. Processor 840 can also include a state machine that uses the outputs from the modules to determine the intended user input and manipulate a string model that corresponds to the intended user input. The state machine string model can output signals that can be used to construct musical notes. These signals can correspond to a trigger, an attack, a decay, a sustain, a note-off, and a release.

The output from the string model can be provided to a control model that is also inside processor 840. The control model can convert the signals into data that recreates the musical notes, such as in MIDI. The processor 840 can send the audio signals to a speaker 850. In some embodiments, additional circuitry (not shown) can interface between the processor 840 and the speaker 850, such as an audio coder-decoder (“CODEC”), an audio amplifier, or audio filters.

Alternatively, the processor 840 may interface with external devices via input/output ports 842. External devices can include a smartphone, a computer, or a laptop. The processor can send the audio signals to these devices for processing or playing. The electronic device 800 may also include controls 844 that interface with the processor 840. The controls 844 can control features such as on/off, volume, usage mode, output settings, communication protocol, etc.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer-implemented method comprising:
receiving a plurality of signals from coupled sensors associated with one or more inputs on an input device;
processing the plurality of signals to obtain characterization data for each of the plurality of signals, the characterization data including each of a signal envelope, a signal maximum, a signal minimum, a signal frequency, a signal slope, and a signal threshold;
analyzing the characterization data by a state machine that incudes a model configured to generate each of a trigger signal, an attack signal, a decay signal, a sustain signal, a note off signal, and a release signal;
based on the analysis of the characterization data, determining at least one event that caused the plurality of signals; and
creating control signals to reproduce the at least one event.

2. The computer-implemented method of claim 1, wherein the input device comprises a musical instrument.

3. The computer-implemented method of claim 2, wherein the coupled sensors are piezoelectric sensors associated with the one or more of strings.

4. (canceled)

5. (canceled)

6. (canceled)

7. The computer-implemented method of claim 1, wherein the signal slope is detected using a run-time root mean square (RMS) filter or an arithmetic mean filter.

8. The computer-implemented method of claim 1, wherein the processing comprises:
filtering each of the plurality of signals; and
adjusting each of the plurality of signals to fit an expected input range.

9. An input device comprising:
a plurality of coupled sensors associated with one or more inputs on the input device, the plurality of coupled sensors configured to detect an event on the one or more inputs and output one or more signals;
a processor configured to:
receive the one or more signals from one or more of the plurality of coupled sensors, the characterization data including each of a signal envelope, a signal maximum, a signal minimum, a signal frequency, a signal slope, and a signal threshold;
analyze the characterization data by a state machine that incudes a model configured to generate each of a trigger signal, an attack signal, a decay signal, a sustain signal, a note off signal, and a release signal;
determine, based on the analysis of the characterization data an event that caused the one or more signals; and
create control signals to reproduce the event.

10. (canceled)

11. The input device of claim 9, wherein the plurality of coupled sensors are piezoelectric sensors.

12. The input device of claim 9, wherein the apparatus further comprises:
an analog front-end configured to:
filter each of the plurality of signals; and
adjust each of the plurality of signals to fit an expected input range.

13. (canceled)

14. (canceled)

15. A non-transitory computer-readable storage medium having stored thereon instructions which, when executed by a processor, cause the processor to perform operations comprising:
receiving a plurality of signals from coupled sensors in a associated with one or more inputs on an input device;
processing the plurality of signals to obtain characterization data for each of the plurality of signals, the characterization data including each of a signal envelope, a signal maximum, a signal minimum, a signal frequency, a signal slope, and a signal threshold;
analyzing the characterization data by a state machine that incudes a model configured to generate each of a trigger signal, an attack signal, a decay signal, a sustain signal, a note off signal, and a release signal;
based on the analysis of the characterization data, determining at least one event that caused the plurality of signals; and
creating control signals to reproduce the at least one event.

16. The non-transitory computer-readable medium of claim 15, wherein the input device comprises a musical instrument.

17. The non-transitory computer-readable medium of claim 16, wherein the coupled sensors are piezoelectric sensors associated with the one or more of strings.

18. (canceled)

19. (canceled)

20. (canceled)

21. The non-transitory computer-readable medium of claim 15, wherein the processing comprises:
filtering each of the plurality of signals; and
adjusting each of the plurality of signals to fit an expected input range.

22. A musical instrument comprising:
a plurality of strings;
a plurality of piezoelectric sensors associated with the plurality of strings;
a processor configured to receive a plurality of signals from the plurality of piezoelectric sensors;
a memory device having instructions stored thereon, which, when executed by the processor, cause the processor to perform steps comprising:
process the plurality of signals to obtain characterization data for each of the plurality of signals, the characterization data including each of a signal envelope, a signal maximum, a signal minimum, a signal frequency, a signal slope, and a signal threshold;
analyze the characterization data by a state machine that incudes a string instrument model configured to generate each of a trigger signal, an attack signal, a decay signal, a sustain signal, a note off signal, and a release signal;
based on the analysis of the characterization data, determine a string from the plurality of strings that caused the plurality of signals;
create control signals to reproduce a sound that corresponds to the string.

23. (canceled)

24. (canceled)
